(19) United States
(12) Patent Application Publication
(10) Pub. No.: US 2019/0299717 A1
(43) Pub. Date: Oct. 3, 2019

(54) WHEEL AND TIRE ASSEMBLY

(71) Applicant: The Goodyear Tire & Rubber Company, Akron, OH (US)

(72) Inventor: Ceyhan CELIK, Stow, OH (US)

(21) Appl. No.: 15/938,464

(22) Filed: Mar. 28, 2018

(51) Int. Cl. B60C 7/10

(52) U.S. Cl. CPC B60C 7/102; B60B 3/00

(57) ABSTRACT

A wheel and tire assembly a plurality of includes support elements for supporting part of a load of a vehicle and an annular shear band extending circumferentially around the support elements. The shear band has a radially inner circumferential membrane, a radially outer circumferential membrane, and a shear layer interconnecting the inner membrane and the outer membrane for controlling shear deflection between the inner membrane and the outer membrane. The shear layer defines a connecting film layer radially sandwiched between a first radially inner, cylindrical flat film layer and a second radially outer, cylindrical film layer. The connecting film layer defines a periodic wave shape as the connecting film layer extends circumferentially between the first and second film layers.

### FIELD OF THE INVENTION

The present invention relates to laminated products or products made of several layers or bands of planar or non-planar form, which are joined together, for example of the cellular type. The present invention relates, more particularly, to resilient (flexible) wheels and tires for motor vehicles.

### BACKGROUND OF THE PRESENT INVENTION

Conventional non-pneumatic tires, when associated with any rigid mechanical element intended to provide a connection between the non-pneumatic tire and a wheel, have in some cases replaced the pneumatic tire, rim and disc utilized with many vehicles.

One conventional non-pneumatic tire may be structurally supported without pressurized gas. The non-pneumatic tire may include a reinforced annular band supporting the load on the tire and a plurality of support elements or spokes having relatively low stiffness in compression and operate in tension to transmit forces between the annular band and a wheel of ta vehicle.

Such an annular band, or shear band, may include two membranes formed from essentially inextensible cords coated with natural or synthetic rubber. The membranes may be separated by a shear layer itself made of rubber. The operating principle of such a shear band may be that a shear modulus of the shear layer may be substantially lower than a tensile modulus of the two membranes. The shear layer may be sufficient, however, to correctly transmit forces from one membrane to the other membrane thus allowing the shear band to work in a shear mode.

The conventional shear band thereby operate in severe or harsh conditions with essentially no risk of puncture and without any pressure maintenance requirement. However, may have a non-uniform Moreover, compared with the non-pneumatic tires of the prior art, a ground contact pressure which is more uniformly distributed, hence better working of the tire, an improved road holding and improved wear resistance are obtained here.

However, such a rubber shear band is not without drawbacks.

Firstly, at the customary operating temperatures, for example between −30° C. and +40° C., it is relatively hysteretic, that is to say that some of the energy supplied for rolling is dissipated (lost) in the form of heat. Next, for significantly lower operating temperatures, such as those that can be found, for example in geographical areas of polar type, typically below −50° C. or even less, it is well known that rubber rapidly becomes brittle, frangible and therefore unusable. Under such extreme conditions, it is moreover understood that temperature fluctuations that are more or less sizable and rapid, combined, for example, with relatively high mechanical stresses, could also lead to adhesion problems between the two membranes and the shear layer, with a risk of localized buckling of the shear band level with the membranes and endurance that is in the end degraded.

### SUMMARY OF THE INVENTION

A wheel and tire assembly in accordance with the present invention includes support elements for supporting part of a load of a vehicle and an annular shear band extending circumferentially around the support elements. The shear band has a radially inner circumferential membrane, a radially outer circumferential membrane, and a shear layer interconnecting the inner membrane and the outer membrane for controlling shear deflection between the inner membrane and the outer membrane. The shear layer defines a connecting film layer radially sandwiched between a first radially inner, cylindrical flat film layer and a second radially outer, cylindrical film layer. The connecting film layer defines a periodic wave shape as the connecting film layer extends circumferentially between the first and second film layers.

According to another aspect of the wheel and tire assembly, the shear layer is constructed of a thermosetting polymer film.

According to still another aspect of the wheel and tire assembly, the shear layer is constructed of polyurethane.

According to yet another aspect of the wheel and tire assembly, the shear layer is constructed of a thermoplastic polymer film.

According to still another aspect of the wheel and tire assembly, the shear layer is constructed of nylon 6, 6.

According to yet another aspect of the wheel and tire assembly, the shear band is secured to the support element by heat sealing.

According to still another aspect of the wheel and tire assembly, the shear band is secured to the support element by adhesive.

According to yet another aspect of the wheel and tire assembly, the shear band is secured to the support element by resorcinol-formaldehyde-latex.

According to still another aspect of the wheel and tire assembly, the shear layer is secured to the inner and outer membranes by resorcinol-formaldehyde-latex.

According to yet another aspect of the wheel and tire assembly, the shear layer is constructed from polyethylene terephthalate.

A non-pneumatic wheel and tire assembly in accordance with the present invention includes a hub member secured to a vehicle, a support element secured to the hub member for supporting part of a load of the vehicle, and an annular shear band extending circumferentially around the support element. the shear band having a radially inner circumferential membrane, a radially outer circumferential membrane, and a shear layer interconnecting the inner membrane and the outer membrane, the shear layer being radially sandwich between the inner membrane and the outer membrane, the shear layer defining a periodic wave shape as the shear layer extends circumferentially between the inner and outer membranes.

According to another aspect of the non-pneumatic wheel and tire assembly, the inner membrane moves in shear relative to the outer membrane under tensile, flexural, and compressive stresses incurred by the structure during rotation of the wheel and tire assembly under a load.

According to still another aspect of the non-pneumatic wheel and tire assembly, the shear layer only deforms elastically under a load.

According to yet another aspect of the non-pneumatic wheel and tire assembly, periodic wave shape only deforms elastically under a load.

According to still another aspect of the non-pneumatic wheel and tire assembly, the inner and outer membranes are constructed of a metal material.

According to yet another aspect of the non-pneumatic wheel and tire assembly, the inner and outer membranes are constructed of a polymer material.

According to still another aspect of the non-pneumatic wheel and tire assembly, the inner and outer membranes are constructed of a fabric material.

According to yet another aspect of the non-pneumatic wheel and tire assembly, the inner and outer membranes are constructed of twisted metals cords.

According to still another aspect of the non-pneumatic wheel and tire assembly, the inner and outer membranes are constructed of twisted organic cords.

According to yet another aspect of the non-pneumatic wheel and tire assembly, the inner and outer membranes are constructed such that the membranes have a maximum tensile strength in the circumferential direction of the wheel and tire assembly.

### Definitions

The following definitions are controlling for this patent application:

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Hysteresis” means the dynamic loss tangent measured at 10% dynamic shear strain and 25° C.

“Inward” directionally means toward the tire cavity.

“Lateral” means an axial direction.

“Lateral edges” means a line tangent to the axially outermost tread contact patch or footprint as measured under normal load and tire inflation, the lines being parallel to the equatorial centerplane.

“Meridian Plane” means a plane parallel to the axis of rotation of a tire and extending radially outward from the axis.

“Net contact area” means the total area of ground contacting tread elements between the lateral edges around the entire circumference of the tread divided by the gross area of the entire tread between the lateral edges.

“Non-pneumatic” means a lack of pressurized inflation gases, such as air, in order to assume a functional or usable form.

“Outward” directionally means in a direction away from the tire cavity.

“Radial” and “radially” means directions radially toward or away from the axis of rotation of the tire.

“Shear Modulus” of elastomeric materials or polymers means the shear modulus of elasticity and may be defined as the equivalent to one-third the tensile modulus of elasticity measured at 10% elongation and 25° C.

“Tread element” or “traction element” means a rib or a block element defined by having a shape adjacent grooves.

### BRIEF DESCRIPTION OF THE DRAWINGS

A detailed description and examples of the present invention are presented in connection with the figures relating to these examples, which schematically show (without a specific scale):

FIG. 1 schematically shows a cross section view of a wheel and tire assembly in accordance with the present invention; and

FIG. 2 schematically shows section of the wheel and tire assembly of FIG. 1 taken along line “2-2”.

### DETAILED DESCRIPTION OF EXAMPLES OF THE PRESENT INVENTION

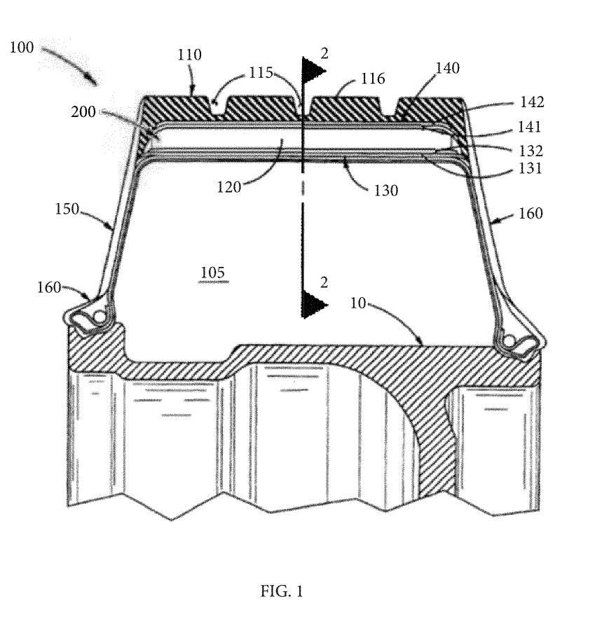

By way of example, FIG. 1 shows an example tire 100 and wheel 10 for use with the present invention. The example tire 100 may be non-pneumatic or pneumatic. The example tire 100 of FIG. 1 may be non-pneumatic, or structurally supported with the tire transferring or carrying a load without the support of gas inflation pressure (e.g., air, nitrogen, etc.).

The tire 100 shown in FIG. 1 may have a ground contacting tread portion, or tread 110, two sidewall portions 150 extending radially inward from the tread 110, and bead portions 160 at a radially inner end of both sidewall portions. The bead portions 160 may anchor the tire 100 to the wheel 10. The tread 110, sidewall portions 150, and bead portions 160 may define a hollow, annular space 105 with or with pressurized gas therein.

A reinforced annular band may be disposed radially inward of tread 110. One example annular band may comprise an elastomeric shear layer, a first membrane having reinforced layers adhered to the radially innermost extent of the elastomeric shear layer, and a second membrane having reinforced layers adhered to the radially outermost extent of the elastomeric shear layer.

The tread 110 may have no grooves or may have a plurality of longitudinally oriented tread grooves 115 forming longitudinal tread ribs 116 therebetween (FIG. 1). Ribs 116 may be further divided transversely or longitudinally to form a tread pattern adapted to the usage requirements of the particular vehicle application. The tread grooves 115 may have any depth consistent with the intended use of the tire 100. The second membrane 140 may be offset radially inward from the bottom of the tread groove a sufficient distance to protect the structure of the second membrane 140 from cuts and small penetrations in the tread 110. The offset distance may increase or decrease depending on the intended use of the tire 100.

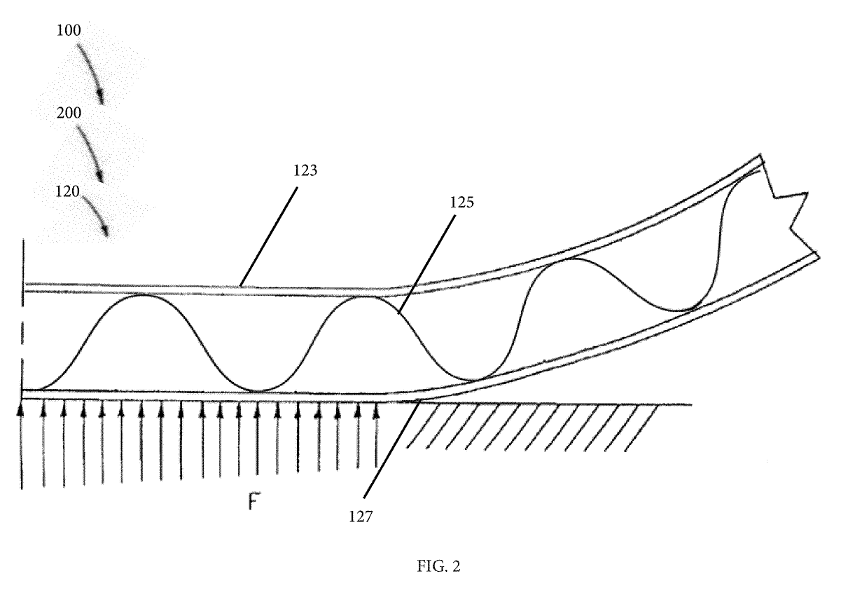

An annular band 200 in accordance with the present invention may comprise an elastomeric shear layer 120, a first membrane 130 having reinforced layers 131, 132 adhered to the radially innermost extent of the elastomeric shear layer 120, and a second membrane 140 having reinforced layers 141, 142 adhered to the radially outermost extent of the elastomeric shear layer 120 (FIG. 2).

Each of the layers of the first and second membranes 130, 140 may comprise inextensible cord reinforcements embedded in an elastomeric coating (e.g., a ply structure). The membranes 130, 140 may be adhered to the shear layer 120 by vulcanization of the elastomeric coating. It is within the scope of the present invention that the membranes 130, 140 may be adhered to the shear layer 120 by any suitable method of bonding, such as chemical, adhesive, mechanical, etc.

The reinforcing elements of the layers 131, 132, 141, 142 may be any material suitable for use as tire belt reinforcements in conventional pneumatic tires, such as monofilaments or cords of steel, aramid, glass, carbon, and/or other high modulus textiles. As an example, the reinforcements may be steel cords of four wires of 0.28 mm diameter (4×0.28). Although variations of the present invention disclosed herein have cord reinforced layers for each of the membranes 131, 132, 141, 142, any suitable material may be employed for the membranes which meets the requirements for the tensile stiffness, bending stiffness, and compressive buckling resistance required of the annular band 200. The membranes 131, 132, 141, 142 may have any suitable structure, such as a homogeneous material, a fiber reinforced matrix, a layer having discrete reinforcing elements (e.g., short fibers, fabric elements, air pockets, twisted organic or inorganic cords, etc.).

In the first membrane 130, the layers 131, 132 may have essentially parallel cords each oriented at an angle relative to the tire equatorial plane with cords of the respective layers having opposite angles or orientation (e.g., +α, −α). Similarly, in the second membrane 140, the layers 141, 142 may have essentially parallel cords each oriented at opposite angles to the equatorial plane, respectively (e.g., +β, −β). The angle of cords of adjacent layers may be different, such as 2×α=β. The angles α, β may be in a range of 10° to 45°. The cords of adjacent layer pairs in a membrane to be oriented at mutually equal and opposite angles. For example, it may be desirable for the cords of the layer pairs to be asymmetric relative to the tire equatorial plane. The cords of each of the layers 131, 132, 141, 142 may be embedded in an elastomeric coating layer typically having a shear modulus of about 20 MPa. The shear modulus of the coating layers may be greater than the shear modulus of the shear layer 120 so that the overall deformation of the annular band 200 is primarily by shear deformation within shear layer 120.

The shear layer 120 in accordance with the present invention may define a connecting film layer 125 radially sandwich between a first radially inner, cylindrical flat film layer 123 and a second radially outer, cylindrical film layer 127. The connecting film layer 125 may be bonded/adhered to the first and second film layers 123, 127. The connecting layer 125, the first layer 123, and the second layer 127 may be a thermosetting polymer film, such as polyurethane, a thermoplastic polymer film, such a nylon 6, 6, and/or other suitable material.

In accordance with the present invention, the connecting film layer 125 may define a periodic wave shape as the connecting film layer extends circumferentially between the first and second film layers 123, 127. The periodic wave shape may define a sine wave (FIG. 2), a square wave, a sawtooth wave, a triangle wave, and/or other suitable periodic wave. Several of the connecting layers 125 may be radially stacked between the first and second membranes 123, 127.

The first and second membranes 123, 127 may be coated with a dip/adhesive material, such as RFL (resorcinol-formaldehyde-latex), to increase bonding/adhering to rubber compounds and/or other suitable polymer compounds. One example RFL adhesive may include a polymer latex which may be based on natural rubber, styrene-butadiene rubber, acrylonitrile-butadiene rubber (NBR), hydrogenated acrylonitrile-butadiene rubber (HNBR) and vinyl pyridine. An optional ingredient to the RFL may be an isocyanate compound. Additional examples of suitable adhesives may be polyvinyl acetate, polyacrylic, polyvinyl chloride and polyurethane. Cement solutions (organic) of polymers may also be used as an adhesive. Representative polymers may include natural rubber, polychloroprene, acrylonitrile-butadiene copolymers, polyisoprene, zinc salts of unsaturated carboxylic acid ester grafted hydrogenated nitrile butadiene elastomers, styrene-butadiene rubbers, polybutadiene, EPDM, hydrogenated acrylonitrile-butadiene copolymers, polyurethane and ethylene-acrylic elastomers.

The RFL adhesive may be first applied to the first and second membranes 123, 127 and the connecting layer 125 may thereafter be applied. The adhesive may be applied to the first and second membranes 123, 127 either before or after being bonded/adhered to the connecting layer 125. There may be many methods for applying adhesive. The adhesive may be applied with a knife, reverse roll or roll-over-platform coaters. Engraved rolls, spray applicators, and/or rotary screen printers may also be used. Other examples may include silk-screen, dipping, brushing, and/or spraying. The thickness of the adhesive may vary, such as from about 0.05 mm to about 1.0 mm, or from 0.05 mm to 0.40 mm The connecting layer 125 may be applied to an adhesive-coated surface either mechanically, electrostatically, and/or by means of a combination of both techniques.

While present exemplary examples of the present invention and methods of practicing the same have been illustrated and described, it will be recognized that the present invention may be otherwise variously embodied and practiced within the scope of the following claims. Other similar flexible membranes, such as vinyl and/or leather, may be used with the connecting layer 125 on the two membranes 123, 127.

This connecting layer 125 layer may thus be used as a non-planar elastic beam, may exhibit a high resistance to flexural/compressive stresses, and a high endurance to alternated stresses or cyclic-loading. The layer 125 may generate a deformation comparable to shear between the first and second membranes 123, 127 under the action of various tensile, flexural, and/or compressive stresses incurred by the annular band 200 structure during rotation of the assembly 10, 100 under load.

The annular band 200 may thus have a high deformation potential in a purely elastic domain. The annular band 200 may be durable and exhibit purely elastic behavior up to rupture. This property may also apply to the membranes 123, 127 when the membranes are themselves made from a composite material (e.g., cords/fibers/resin). Compared with a metal annular band, the annular band 200 may be more durable, substantially lighter, and/or more corrosion resistant.

The assembly 10, 100 of the present invention may be used in all types of land based or non-land based vehicles and, in particular, vehicles intended to face severe or harsh rolling conditions or extreme temperatures, such as those which could be encountered, for example, by lunar rover vehicles, road transport vehicles, off-road vehicles and/or any other type of transport or handling vehicles.

The membranes 123, 127 may have a longitudinal tensile modulus of elasticity sufficiently greater than the shear modulus of elasticity of the elastomeric shear layer 125 such that, under an externally applied load, the ground contacting tread portion deforms from essentially a circular contact shape to a flat shape while maintaining an essentially constant length of the membranes. Relative circumferential and axial displacement of the membranes 123, 127 occurs by shear in the shear layer 125. As shown in FIG. 2, a beneficial result may be a more uniform ground contact pressure throughout the length of the contact area compared to other tires not using an annular band 200 having the deformation properties in accordance with the present invention. The annular band 200 may not rely on internal inflation pressure to have a transverse stiffness in a tire meridian plane and a longitudinal bending stiffness in the tire equatorial plane sufficiently high to act as a load-supporting member.

Variations in the present invention are possible in light of the description of examples of it provided herein. While certain representative examples and details have been shown for the purpose of illustrating the present invention, it will be apparent to those skilled in this art that various changes and modifications may be made therein without departing from the scope of the present invention. It is, therefore, to be understood that changes may be made in the examples described which will be within the full intended scope of the present invention as defined by the following appended claims.

What is claimed:

1. A wheel and tire assembly comprising:
a plurality of support elements for supporting part of a load of a vehicle; and
an annular shear band extending circumferentially around the support elements, the shear band having a radially inner circumferential membrane, a radially outer circumferential membrane, and a shear layer interconnecting the inner membrane and the outer membrane for controlling shear deflection between the inner membrane and the outer membrane, the shear layer defining a connecting film layer radially sandwich between a first radially inner, cylindrical flat film layer and a second radially outer, cylindrical film layer, the connecting film layer defining a periodic wave shape as the connecting film layer extends circumferentially between the first and second film layers.

2. The wheel and tire assembly as set forth in claim 1 wherein the shear layer is constructed of a thermosetting polymer film.

3. The wheel and tire assembly as set forth in claim 1 wherein the shear layer is constructed of polyurethane.

4. The wheel and tire assembly as set forth in claim 1 wherein the shear layer is constructed of a thermoplastic polymer film.

5. The wheel and tire assembly as set forth in claim 1 wherein the shear layer is constructed of nylon 6, 6.

6. The wheel and tire assembly as set forth in claim 1 wherein the shear band is secured to the support elements by heat sealing.

7. The wheel and tire assembly as set forth in claim 1 wherein the shear band is secured to the support elements by adhesive.

8. The wheel and tire assembly as set forth in claim 1 wherein the shear band is secured to the support elements by resorcinol-formaldehyde-latex.

9. The wheel and tire assembly as set forth in claim 1 wherein the shear layer is secured to the inner and outer membranes by resorcinol-formaldehyde-latex.

10. The wheel and tire assembly as set forth in claim 1 wherein the shear layer is constructed from polyethylene terephthalate.

11. A non-pneumatic wheel and tire assembly comprising:
a hub member secured to a vehicle;
a support element secured to the hub member for supporting part of a load of the vehicle; and
an annular shear band extending circumferentially around the support element, the shear band having a radially inner circumferential membrane, a radially outer circumferential membrane, and a shear layer interconnecting the inner membrane and the outer membrane, the shear layer being radially sandwich between the inner membrane and the outer membrane, the shear layer defining a periodic wave shape as the shear layer extends circumferentially between the inner and outer membranes.

12. The non-pneumatic wheel and tire assembly set forth in claim 11 wherein the inner membrane moves in shear relative to the outer membrane under tensile, flexural, and compressive stresses incurred by the structure during rotation of the wheel and tire assembly under a load.

13. The non-pneumatic wheel and tire assembly set forth in claim 11 wherein the shear layer only deforms elastically under a load.

14. The non-pneumatic wheel and tire assembly set forth in claim 11 wherein periodic wave shape only deforms elastically under a load.

15. The non-pneumatic wheel and tire assembly set forth in claim 11 wherein the inner and outer membranes are constructed of a metal material.

16. The non-pneumatic wheel and tire assembly set forth in claim 11 wherein the inner and outer membranes are constructed of a polymer material.

17. The non-pneumatic wheel and tire assembly set forth in claim 11 wherein the inner and outer membranes are constructed of a fabric material.

18. The non-pneumatic wheel and tire assembly set forth in claim 11 wherein the inner and outer membranes are constructed of twisted metals cords.

19. The non-pneumatic wheel and tire assembly set forth in claim 11 wherein the inner and outer membranes are constructed of twisted organic cords.

20. The non-pneumatic wheel and tire assembly set forth in claim 11 wherein the inner and outer membranes are constructed such that the membranes have a maximum tensile strength in the circumferential direction of the wheel and tire assembly.
